(19) United States
(12) Patent Application Publication
(10) Pub. No.: US 2014/0137144 A1
(43) Pub. Date: May 15, 2014

(54) SYSTEM AND METHOD FOR MEASURING AND ANALYZING AUDIENCE REACTIONS TO VIDEO

(71) Applicants: Mikko Henrik Järvenpää, Helsinki (FI); Kalle Oskari Korhonen, Newark, CA (US)

(72) Inventors: Mikko Henrik Järvenpää, Helsinki (FI); Kalle Oskari Korhonen, Newark, CA (US)

(21) Appl. No.: 13/674,683

(22) Filed: Nov. 12, 2012

(51) Int. Cl. H04N 21/475

(52) U.S. Cl. CPC H04N 21/475
USPC 725/13; 725/9

(57) ABSTRACT

A system and method for measuring and recording viewer reactions to content is provided. In an embodiment, the reactions are analyzed and the analysis is put into a report. The analysis may be of interest to the supplier of the content. In an embodiment, a viewer may view the content in combination with the reactions of others thereby creating an enhanced viewing experience. In an embodiment, highlights of the content may be compiled and combined with the reactions of the viewers of the content. In an embodiment, audience reactions may be recorded in real-time, and analysis, visualization, and report of the reactions may be prepared, which may be used for the purpose of playback along with the content, and/or for the information needs of the content supplier and/or interested parties.

### FIELD

This specification generally relates to methods of measuring reaction to online videos.

### BACKGROUND

The subject matter discussed in the background section should not be assumed to be prior art merely as a result of its mention in the background section. Similarly, a problem and the understanding of the causes of a problem mentioned in the background section or associated with the subject matter of the background section should not be assumed to have been previously recognized in the prior art. The subject matter in the background section may merely represents different approaches, which in and of themselves may also be inventions.

Viewing and posting of videos online has become a popular activity in the recent years. Large services such as YouTube have established themselves as central clearinghouses where video is posted and watched. Similar, smaller internet video sites have established themselves to serve niche content. However, there exist very limited possibilities for interacting with internet video.

### SUMMARY

The system and method for measuring and analyzing audience reactions to video provides real-time recording of audience reactions, and analysis and reporting of said reactions both for purposes of playback along with the video content, and for the information needs of the video uploader. In at least one embodiment, the system and method for measuring and analyzing audience reactions to video provides a reaction histogram timeline which shows the audience reaction as a function of time. The audience reaction may be the reaction of one member of the audience, a demographic representation of the audience and/or the total audience.

In at least one embodiment, the system and method relies on recording the reactions of the members of the audience. In at least one embodiment, the recording happens via a selection of reaction buttons that the viewer can click in real time while watching the video to indicate a certain kind of a reaction to an event in the internet video in question.

In at least one embodiment, the recording happens via the voice recording of the viewer and the analysis of the audible reactions to the video while watching the video. The voice recordings are automatically categorized into standardized categories, for example laughter, applause or booing. In another embodiment, the reactions are recorded by simultaneous video recording of the viewer and the analysis of their gestures.

In at least one embodiment, the system and method also relies on the analysis of the reactions and the time-dependent reporting of the reactions. In at least one embodiment, the reactions are constructed into a histogram that displays how the audience has reacted to the video at various points throughout the duration of the video. In embodiments in which a histogram is constructed, the histogram can be, for example, displayed over a chronological and/or thumbnail view of the video.

In at least one embodiment, the reactions are used to enrich the playback of the video. Reactions categorized as laughter, for example, at a certain point in the video can be interpreted in the playback as an added sound effect of laughter, thus including the audience reactions into the video viewing experience. The reactions can be weighted against each other and analyzed to, for example, remove outliers and to construct an audio representation of the reactions of the whole audience. The audio representation with the outliers removed can be accessed either privately by the uploader (e.g., owner, producer, videographer or interested party) only, or publicly by any viewer to enrich the video viewing experience. In this specification, although an uploader is referred to throughout the specification, as an example, an administrator of the content, the owner of the content, the supplier of the content, or another interested party may be substituted for the uploader to obtain other embodiments. The owner of the content, the administrator of the content, the supplier of the content, and the other interested party are not necessarily uploaders of the content, and the content is not necessarily uploaded.

In at least one embodiment, the uploader provides the system with a live video stream. Audience reactions to the live video stream may be recorded, analyzed and reported in real-time to the uploader. Having the audience reaction recorded, allows the audience reaction to be directed to the content of the live video stream based on real time feedback.

In at least one embodiment, the system and method relies on a front end user interface for viewing and interacting with the internet videos. In at least one embodiment, the front end user interface, in addition to containing the video viewing window and control buttons known from prior art systems, also contains the reaction buttons. In at least one embodiment, the control buttons are reaction button sets that are specific to content type. For example, an education content might have different reaction buttons than a sports video. In at least one embodiment, the front end will additionally contain controls for recording the audio and video of the viewer reactions.

In at least one embodiment, the system and method relies on a user interface back end for analyzing and viewing the records of audience reactions to the video. In at least one embodiment, the uploader of the video is able to view a histogram of the video reaction superimposed on a chronological view of the video thumbnails.

In at least one embodiment, the system and method provides multiple benefits because the system and method allows for real-time recording of reactions to video content, instead of just rating the video after the fact. In at least one embodiment, the system and method also allows for video viewers to enrich their experience by contributing to and viewing the video with audience reactions turned on, thus participating in a more communal experience of video watching. For the uploader of the video, the system and method allows for the analysis of the reactions to the contents of the video, thus providing a much more detailed report of audience interaction.

Any of the above embodiments may be used alone or together with one another in any combination. Inventions encompassed within this specification may also include embodiments that are only partially mentioned or alluded to or are not mentioned or alluded to at all in this brief summary or in the abstract.

### BRIEF DESCRIPTION OF THE FIGURES

In the following drawings like reference numbers are used to refer to like elements. Although the following figures depict various examples of the invention, the invention is not limited to the examples depicted in the figures.

FIG. 1 illustrates a flowchart of an embodiment of a method for measuring and analyzing audience reactions to video.

FIG. 2 illustrates a flowchart of an embodiment of a user-side method for measuring and analyzing audience reactions to video.

FIG. 3 illustrates a flowchart of an embodiment of a server-side method for measuring and analyzing audience reactions to video.

FIG. 4 illustrates a flowchart of an embodiment of an uploader-side method for measuring and analyzing audience reactions to video.

FIG. 5A illustrates a screenshot of an embodiment of a front end user interface.

FIG. 5B illustrates a screenshot of an embodiment of a back end user interface.

FIG. 6A illustrates a screenshot of an embodiment of a portion of a front end user interface.

FIG. 6B illustrates a screenshot of an embodiment of a portion of a front end user interface.

FIG. 7 illustrates a block diagram of an example of a system in which a method for measuring and analyzing audience reaction to videos may be used.

FIG. 8 shows a block diagram of a computer used in an embodiment of a method for measuring and analyzing audience reactions to video.

FIG. 9 shows a block diagram of an embodiment of the memory system used in an embodiment of the computer of FIG. 8.

### DETAILED DESCRIPTION

Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

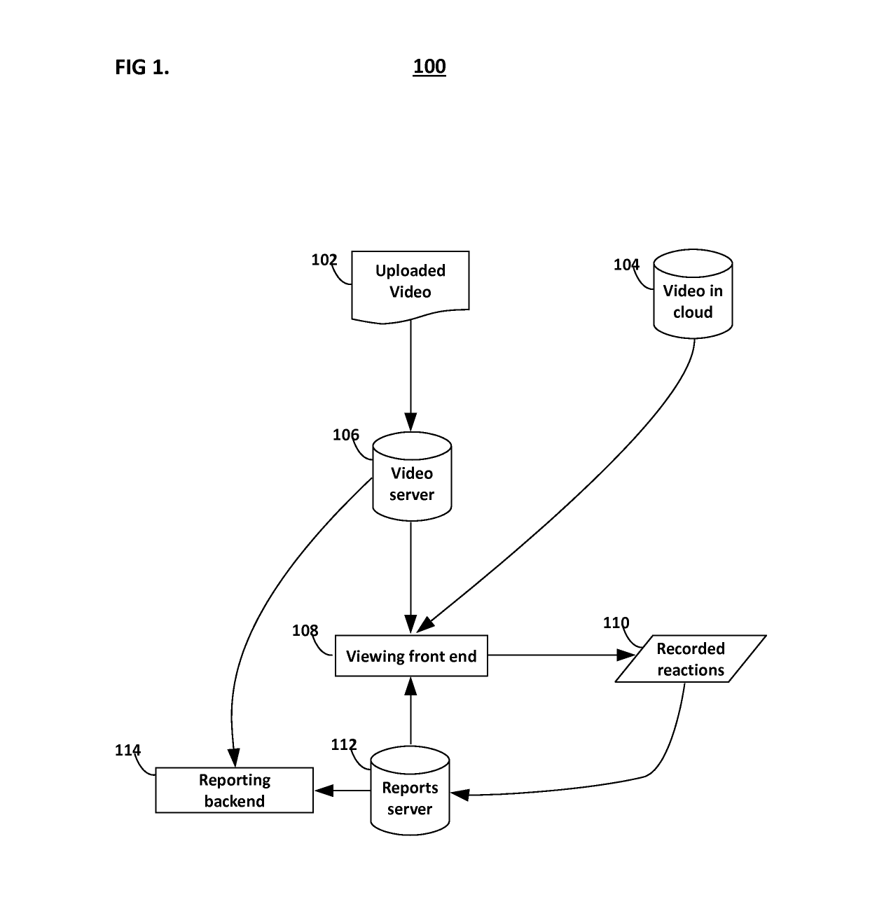

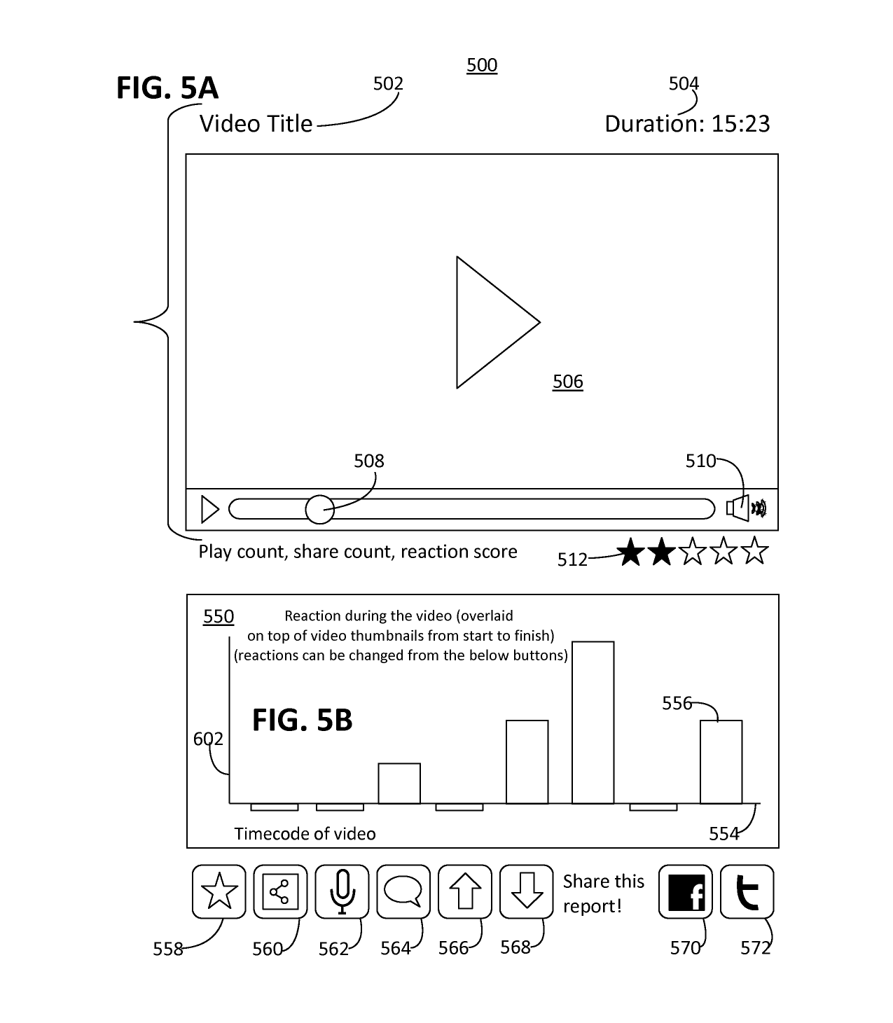

In general, at the beginning of the discussion of each of FIGS. 5, 6, and 7-9 is a brief description of each element, which may have no more than the name of each of the elements in the one of FIGS. 5, 6, and 7-9 that is being discussed. After the brief description of each element, each element is further discussed in numerical order. In general, each of FIGS. 5, 6, and 7-9 is discussed in numerical order and the elements within FIGS. 1-9 are also usually discussed in numerical order to facilitate easily locating the discussion of a particular element. Nonetheless, there is no one location where all of the information of any element of FIGS. 1-9 is necessarily located. Unique information about any particular element or any other aspect of any of FIGS. 1-9 may be found in, or implied by, any part of the specification.

In various places in discussing the drawings a range of letters, such as a-g, are used to refer to individual elements of various series of elements that are the same. In each of these series, the ending letters are integer variables that can be any number. Unless indicated otherwise, the number of elements in each of these series is unrelated to the number of elements in others of these series. Specifically, even though one letter (e.g. “c”) comes earlier in the alphabet than another letter (e.g., “d”), the order of these letters in the alphabet does not mean that the earlier letter represents a smaller number. The value of the earlier letter is unrelated to the later letter, and may represent a value that is greater the same or less than the later letter.

Although exemplary embodiments of the present invention have been described with reference to the attached drawings, the present invention is not limited to these embodiments, and it should be appreciated to those skilled in the art that a variety of modifications and changes can be made without departing from the spirit and scope of the present invention.

FIG. 1 shows a flowchart of an embodiment of a system and method for measuring and analyzing audience reactions to video 100. Although throughout this specification video is discussed, the specification is not limited to video content. Wherever video (or other specific content) and viewing video (or presenting other content) is discussed in this specification, any other content may be substituted to obtain other embodiments. Any mention of any specific content may be substituted with any other specific content to obtain a different embodiment and thus references to video, audio, and slides, for example may be substituted one for another. FIG. 1 presents an example of a sequence of events according to one embodiment of the invention.

The system and method are useful because the possibilities to interact with videos via the internet currently do not meet the normal, real-world behavior of video audiences. The reporting of audience interactions is also very limited and does not meet the full information needs of video producers. Video analytics via the internet only offer reports related to video controls and traffic, not interactions and reactions related to the content of the video. In at least one embodiment, the system and method for measuring and analyzing audience reactions to video provides a reaction histogram timeline which shows the audience reaction as a function of time. The audience reaction may be the reaction of one member of the audience, a demographic representation of the audience and/or the total audience.

Thus, interaction with internet videos has been only control-related or a negative/positive indication of whether the content as a whole was liked or not by the viewer. It is possible that in the duration of the video, there were moments that were of interest to viewers and moments that were not, but there is no structured way for the viewers to indicate those moments, or the reactions taking place at those moments. The producer, uploader or owner of the video content has only been able to see whether their video was liked or not, or whether the users skipped to another video, paused the video, or pressed rewind.

The problem with the present state of internet video is that it is not possible for users to react in meaningful ways to video content throughout the video. The users are not able to indicate their reactions throughout the video the users are viewing, and importantly, the users are not able to interact with other members of the audience as viewers can in real-world situations. Laughter prompted by a good joke halfway through a video can be heard by other members of the audience, but laughter of other viewers of internet video cannot be heard. The problem with current systems is similar on the uploader's side. The uploader is not able to see what the audience reactions are to different parts of their video. The uploaders may need more detailed insights into their videos, and, more accurately, the uploaders may need information as to what moments in the video exactly provoked what kinds of reactions. Information about the points in the video that received a particular reaction may be very valuable as the correlation between the reaction and the portions of the video that generated the reaction can tell uploaders what content exactly is valuable or produces a desirable reaction in the audience. Traditionally, film producers have, for example, arranged prescreening of movies where audience reactions have been observed and recorded, and the movie edited accordingly before a wider release. With internet video, it is currently not possible to measure the reaction of a large audience to a prescreening of a movie. Nor is it possible in the case of live video streams, where the producer needs to provide content appreciated by the audience. Without being able to record, analyze and report the reactions in real time, the producer cannot guide the content of the video.

The video analytics available via the internet currently rely on analyzing and reporting the sources and volumes of viewing traffic. There has been no way of analyzing the content of the videos themselves based on real or reported audience reactions.

For example, if one considers a five-minute video of football highlights being watched over the internet. The video features ten best goals of the week, two news reports and an interview of a player. A viewer at home reacts to the goals by applause, laughter or booing, for example, but the reaction of other viewers is not conveyed to viewers internet video in any way. If the viewer at home wanted to convey their reactions, the viewer would need to write textual comments to the video and indicate the times at which the event that prompted the viewer's reaction occurred.

As another example, another viewer wants to view the same video that has now been watched thousands of times. The video has prompted various reactions at different times during those five minutes that the video runs. Yet the new viewer would have no way of accessing those reactions, to, for example, isolate the moment that has been the most popular and to just watch that moment instead of the whole five minutes. Again, only by browsing the stream of text comments could a viewer currently determine the part of the video that received a particular reaction, and the viewing of the text stream would not necessarily be enriching.

As a third example, from the perspective of the uploader of the same five-minute long football video. In systems currently available via the internet, the uploader is only able to see how many people watched the video, how the viewers rated the video and whether viewers paused the video or skipped ahead at certain times. The uploader is not able to see whether the interview on the video caused a positive or a negative reaction, or more generally, how the viewers reacted to the answers given by the player in the interview.

Therefore, systems and methods for measuring and analyzing audience reactions to video via the internet are provided. The systems and methods allow an uploader (owner, producer, videographer or interested party) to analyze the reactions to a video in real time.

In the embodiment shown in FIG. 1, in step 102, a video is uploaded or streamed by the user 102 or embedded from another service or from another source 104. In the first case, the uploaded video is stored on server 106 containing the video serving and streaming computer programs needed to serve the video content to the viewer. In the second case, the embedded video from another source is placed in the viewing front end 108. In the viewing front end, the user watches the video and interacts with the video by, for example, clicking on buttons that indicate certain emotional or rational responses to events in the video. These interactions are recorded in real-time 110 and passed on to the server 112. The server receives the reactions based on their content and timecode, analyzes the reactions by their category based on the preferences of the uploader, and by their statistical significance and strength. The server also associates with the reaction the viewer information, such as demographics or recent activity, if applicable. The server stores the reactions and the associated information in a rapidly accessible standard database, which is queried by the reporting back end. The reactions are presented in a visual report to the uploader in the reporting back end 114, where the uploader finds the collated analysis of the reactions to the video content. In the reporting back end, the uploader is also able to view reaction reports in association with audience information, such as demographics, where applicable and available (demographic information may be determined from the account information). In the case of streaming live content, measuring the reaction and viewing the reaction measured may be handled in real-time to allow the uploader to receive instant feedback to the video content.

The server analyzes the reactions based on uploader preferences. For example, the uploader may be interested in only finding out the events that prompt laughter (or other reaction) in the audience. The server will then analyze the reactions as the reactions are received and find the statistically significant reactions among the reactions received, eliminating outliers. Outlier elimination may be done dynamically on the reporting server, and the extent to which outliers are removed from the data set can be influenced by the uploader. The uploader can select parameters that define what is considered an outlier. For example, if less than 5% of the viewers react at the same time, that reaction will not be represented in the report, or will not be played back when the video is viewed with the audience reaction playback turned on.

The server also corrects the timing of the reactions. In at least one embodiment, the reactions to video content are given by clicking on the reaction buttons. In at least one embodiment, the control/reaction buttons are reaction button sets that are specific to content type. For example, an education content might have different reaction buttons than a sports video. The reaction may in many user cases include a time lag from the event to the recording of the reaction, and therefore a 0.3 second timing correction (for example) with regards to the reaction being tied to an event is taken as the starting point for the timing correction. Timing may also be corrected dynamically. When multiple reactions cluster around a single point in the video with no other reactions close to the cluster, the server may consider the cluster of reactions to belong to a single event and the mean or mode timecode of those reactions as the time of the event causing the cluster of reactions. The exact amount of reaction time correction of the cluster of reactions is determined by user testing the reactions in different ways, which may be augmented by the use of reaction recordings that are not likely to include any time lag, such as audio and video recording of reactions, whether the recording is made on the same machine on which the video is viewed (so that there is no lag due to the transit time of the stream over the network).

In at least one embodiment, each of the steps of method 100 is a distinct step. In another embodiment, although depicted as distinct steps in FIG. 1, step 1-7 may not be distinct steps. In other embodiments, method 100 may not have all of the above steps and/or may have other steps in addition to or instead of those listed above. The steps of method 100 may be performed in another order. Subsets of the steps listed above as part of method 100 may be used to form their own method.

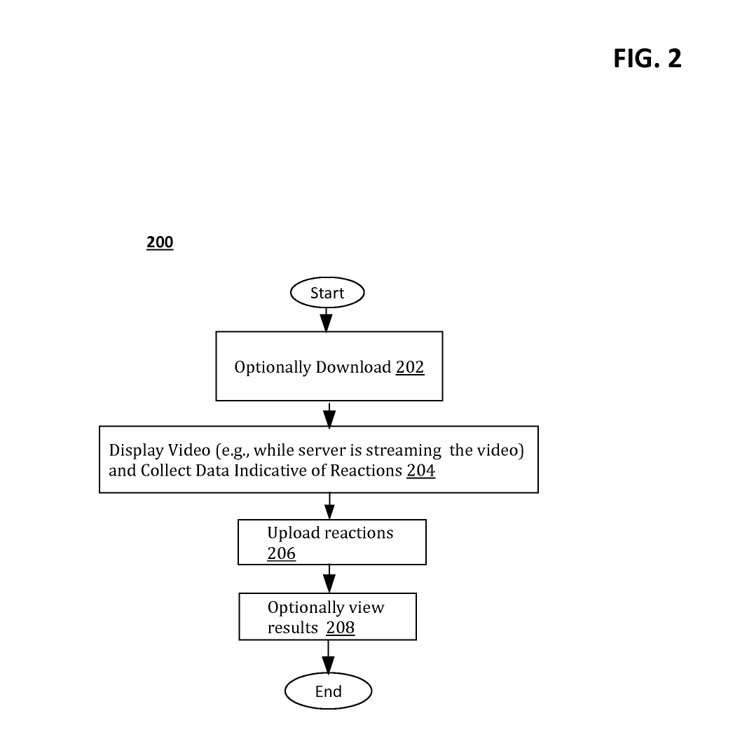

FIG. 2 shows a flowchart of an embodiment of a user-side method 200 for measuring and analyzing audience reactions to video. Method 100 allows for video viewers/users to enrich their experience by contributing to and, in at least one embodiment, viewing the video with audience reactions turned on, thus participating in a more communal experience of video watching. Method 200 may be a method for measuring and analyzing audience reactions to a video or other media, which is performed at the machine of the user that views the video.

In step 202, a viewer downloads a video to the viewer's system. The viewer may find the video on the specific website for analyzing audience reactions to the video or may find a video in any video website available, such as, Youtube, Ted, Current TV, Big Think, Atom, Blip.tv, 5 min, WwiTV, Hulu, Vimeo. In at least one embodiment, the video chosen by the user has been downloaded (concurrently or separately) and registered with the system to be analyzed for the viewer's reactions. In at least one embodiment, when the video is downloaded, the system also downloads software that causes the viewer's computer to monitor, analyze, and/or record the viewer's reactions.

In step 204, the viewer displays the video (e.g., while the server is streaming the video and collects data indicative of the reactions). The viewer streams, watches, and/or interacts with the video (throughout the discussion of method 200 the word viewer may be substituted for the word user and the word user may be substituted for the word viewer to obtain different embodiments). In at least one embodiment, when the viewer watches the video, the type of reaction that is analyzed is automatically chosen for the viewer (audio, video, and/or manual). In at least one embodiment, the viewer may choose the type of input that is recorded as a reaction (such as audio, video, and/or manual).

Also during step 204, the viewer interacts with the video, via the audio, video and/or manual methods (as determined by step 204). In at least one embodiment, viewers watching the videos (users) are given the opportunity to indicate their reaction to the events in the video by clicking on one or more buttons (which may be referred to as reaction buttons) below the video viewing screen. The reaction buttons may be provided that contain chosen reactions to a video (e.g., laugh, cry, frown, boo, yell, anger, frustration, smile, disbelief, etc.). Although a button is used as an example, the button may be replaced with any user interface element (e.g., a radio nob, slide bar, etc.) that may be activated with a simple motion that activates a tracking device (e.g., a mouse or touch pad), keypad or other input device. Recording the reaction may occur via the selection of reaction buttons that the viewer/user can click in real-time while watching the video to indicate a certain kind of a reaction to an event in the internet video in question. In at least one embodiment, optionally a viewer is also given the choice of summarizing their reactions to the video during or at the end of the video.

In at least one embodiment, audio reactions are analyzed in real-time. As the user is watching, the viewer may laugh, cry, boo, etc. and the reaction is analyzed. In at least one embodiment, an audio recording of the viewer is made that includes an analysis of the audible reactions of the viewer to the video while watching the video. In at least one embodiment, the audio recordings may be automatically categorized into standardized categories, for example laughter, applause or booing.

In at least one embodiment, video reactions that were recorded are analyzed. As the user watches the video, facial expressions, hand gestures, body reactions and/or other movements are recorded and/or analyzed. In at least one embodiment, the reactions are recorded by simultaneously making a video recording of the viewer and an analysis of the viewer's gestures.

Optionally, as part of step 204, the user may choose to watch the video while viewing an indication of the reactions of others, optionally simulating watching the video with others in the same room.

In step 206, the viewer uploads data indicative of the reactions. Step 206 is optional and occurs when software has been downloaded to the viewer's machine to enable the viewer's reactions to be analyzed. After the reactions are analyzed/monitored/recorded, the reactions may be uploaded to the server for analysis. The uploading of the reaction to the server may happen at the end of the viewing or at any time during the viewing. The uploading of the reaction to the server may happen once or alternatively may happen continuously as the video is viewed. In an embodiment, method 200 ends with step 206. Alternatively, method 200 may have an additional step, step 208.

In step 208, the user/viewer views the results. In at least one embodiment, the user is optionally given a choice of viewing the recording of, and/or the results of, an analysis of the viewer's reactions. The results may include the viewer's reaction and/or may represent the reactions of all of the viewer of the video. In at least one embodiment, the reaction can be turned on or off (thereby not allowing the viewer to observe the reactions and/or the results of the analysis of the viewer's reactions as the viewer watches the video). In at least one embodiment, the viewer's interface (which may be referred to as the front end) is set up for recording a given set of reactions, which may be fixed or determined by the uploader of the video, and cannot be changed by the viewer.

The viewer may also be given an option to add comments about the video and/or to view their own reactions and make changes. By allowing the viewer to enter comments, if a wrong button was pushed, the viewer may have the option of correcting the reaction.

In at least one embodiment, the viewer may complete a questionnaire giving information about the viewer and/or the demographics of the viewer (the type of demographic information collected may be chosen by the downloader). The questionnaire may be voluntary or may be required to watch the video. In at least one embodiment, an incentive may be given for the viewer to fill out the questionnaire. The viewer may be given the option to fill out a questionnaire and/or personal information about the viewer (e.g., age, sex, income, political leanings, insurance, family information, type of house, interests, type of car, children, pets, products the viewer buys, hobbies, and/or the number of times the viewer goes to the movies, etc.) or a questionnaire may be required. In at least one embodiment, the viewer may be given an incentive (a prize) for filling out the questionnaire (e.g., a gift certificate, a coupon, a chance to win a prize, a free movie/video, etc.). In at least one embodiment, the viewer may have to fill out the questionnaire to be able to view the video.

In an embodiment, each of the steps of method 200 is a distinct step. In another embodiment, although depicted as distinct steps in FIG. 2, step 202-208 may not be distinct steps. In other embodiments, method 200 may not have all of the above steps and/or may have other steps in addition to or instead of those listed above. The steps of method 200 may be performed in another order. Subsets of the steps listed above as part of method 200 may be used to form their own method.

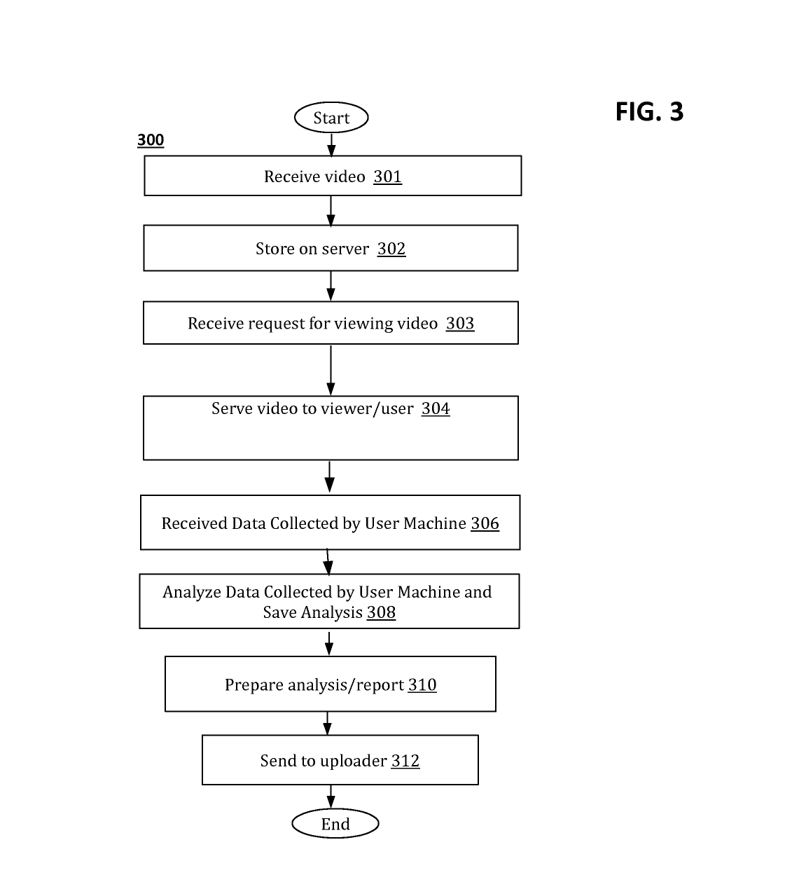

FIG. 3 shows a flowchart of an embodiment of a server-side method 300 for measuring and analyzing audience reactions to video in which:

In at least one embodiment, method 300 is performed, via one user interface for viewing and interacting with the internet videos and another user interface for the uploader for analyzing and viewing the results of the reactions.

In at least one embodiment, the user interface for the front end, in addition to containing the video viewing window and control buttons also contains reaction buttons. In at least one embodiment, the front end may additionally contain controls for recording the audio and video of the viewer reactions.

In at least one embodiment, the system includes an user interface for the back end for analyzing and viewing the records of audience reactions to the video. In at least one embodiment, the user interface for the back end is provided for the uploader. In at least one embodiment, after the video has been viewed for a desired time, the uploader of the video is able to view a histogram of the video reaction superimposed on a chronological view of the video thumbnails. In step 301, the video is received at the server as a result of being uploaded or embedded from other sources. The video may be uploaded by the uploader, which results in the server receiving the video. The uploader may be a producer, videographer, owner, or interested party. For example, a Democratic politician might want to upload a Republican video to analyze the general public's reaction to the video. Alternatively, a company may want to analyze the general audience reaction to a television or internet advertisement for a product.

In step 302, the video is stored by the server in the memory. The video may be stored in combination with information about the uploader and/or videographer. Further, the server may receive a choice of the type of reactions that will be recorded and/or analyzed (such as audio, video, manual only, other types of responses, and/or combinations) which may be stored in combination with the video. The uploader may also receive a choice of which manual buttons to include and/or whether to allow comments, ask the viewer to fill out a questionnaire, require the viewer to fill out a questionnaire, etc. In at least one embodiment, the uploader's interface (which may be referred to as the front end) is set up for recording a given set of reactions and cannot be changed by the uploader.

In step 303, the server receives a request from a viewer to view the video. The request may involve the viewer downloading a video from the server, entering user information into a user interface.

In step 304, in response to receiving the request from the viewer to view the video, the server serves the video content to the viewer/user.

In step 306, the server receives data collected by the user/viewer machine about how the viewer is reacting. As viewers watch the videos and click “applause”, for example, the reactions are received by the server, which records the time, content and associated viewer information of the reaction. The server may receive data about all of the reactions. Data representing the reactions may be stored in manner so that the reactions are correlated to the portion of video to which the reactions correspond. The server may perform a time correction to compensate for the reaction lag time, which is the lag time between a particular portion of the video being sent for viewing or being displayed and the time that it takes the reaction to be recorded and received by the server or another machine recording the reactions. The delay may be due to the reaction time of the viewer and/or the time that it takes a portion of the video to arrive at the viewer's machine and the indication of the reaction to be sent from the viewer's machine back to the server. The server may also cluster similar reactions or opposing reactions happening at the same point in the video to represent the larger audience reactions in the reports.

In step 308, the data about the reactions that were uploaded are analyzed. The data collected by the viewer machine is analyzed and saved to memory. The data collection may involve a simple analysis, such as identifying the buttons that were pushed at particular times during the video. Or, that analysis may involve a more complicated analysis, such as categorizing the different types of reactions and such as identifying what an audio reaction is (a laugh, a boo, a cheer, etc.) and separating out undesired reactions (coughs, yelling at someone in the room, etc.). Separating undesired reactions may also involve analyzing reactions that are being videotaped (facial expressions, body language, etc.). The reactions may be the buttons that are pushed and the timing of when the buttons are pushed. In at least one embodiment, the reactions are voice recordings and are automatically categorized into standardized categories, for example laughter, applause, or booing. In at least one embodiment, the collection of the data and/or the analysis is performed while streaming the video by the server. In at least one embodiment, if the video is streamed to the viewer and the analysis by the viewer's computer is not necessary, the method goes directly to step 310 after collecting the data about the reactions. In method 300, the server may stream the video to the viewer's machine and the server may analyze the reactions collected by the server.

In step 310, after analyzing the reactions, an analysis/report is prepared for the uploader and/or others to view. The report may include histograms of different types of reactions. The analysis may include a computation of a mean time, standard deviation of the time of the reaction, standard error of the time of the reaction, mode of the time of the reaction, of a cluster of reactions In at least one embodiment, the server keeps the data about the reactions in the server's memory until the report is sent. In at least one embodiment, the server keeps the data about the reactions and/or the analysis in the server's memory indefinitely or for another time period. The uploader may choose the format of the report and how the reports are generated (e.g., once every day, once every 10 days, once every 1 month, once every 1 year, etc.). In at least one embodiment, the uploader may choose to receive a report after a certain number of viewers has viewed the video (e.g., after 10 viewers, 100 viewers, 1000 viewer, 10,000 viewers, etc.). The server can use a variety of methods to analyze the reactions depending on how the reactions are measured (audio, video, manual). In at least one embodiment, software is used to analyze the reactions and/or to associate the reactions with specific demographical groups of viewers. An analysis/visual report is prepared, for example, showing the reactions by time and/or in combination with demographic information. In at least one embodiment, the reactions are constructed into a histogram that displays how the audience has reacted to the video at various points throughout the duration of the video. In this embodiment the histogram (e.g., including error bars) can be for example displayed over a chronological thumbnail view of the video.

In step 312, the report is sent form the server to the system of the uploader. In at least one embodiment, the report may also be sent to a user/viewer of the video. The report may be sent in the form of a histogram, a list, a percentage of each reaction, etc. In at least one embodiment, the reactions are used to enrich the playback of the video. In this embodiment, reactions categorized as laughter, for example, at a certain point in the video can be interpreted in the playback as an added sound effect of laughter, thus including the audience reactions into the video viewing experience. The reactions may be weighted against each other and analyzed to, for example, remove outliers and to construct an audio representation of the reactions of the whole audience. In an embodiment, the audio representation can be accessed either privately by the uploader only or, in another embodiment, the audio Reactions can be used to automatically find the most interesting parts of the video and provide the interesting parts in an automatically edited highlight compilation for viewing. The highlight compilation may be based on viewer reactions. The highlight compilation can be produced by using the portions of the video that showed the strongest reactions. The reactions can be any type of reaction, including but not limited to, laughter, crying, booing, cheering, etc. The highlight compilations may be provided in any type of a sequence, including, but not limited to, chronological order, by popularity, by strength of reaction, by positivity of reaction, etc.

In an embodiment, each of the steps of method 300 is a distinct step. In at least one embodiment, although depicted as distinct steps in FIG. 3, step 302-312 may not be distinct steps. In other embodiments, method 300 may not have all of the above steps and/or may have other steps in addition to or instead of those listed above. The steps of method 300 may be performed in another order. Subsets of the steps listed above as part of method 300 may be used to form their own method.

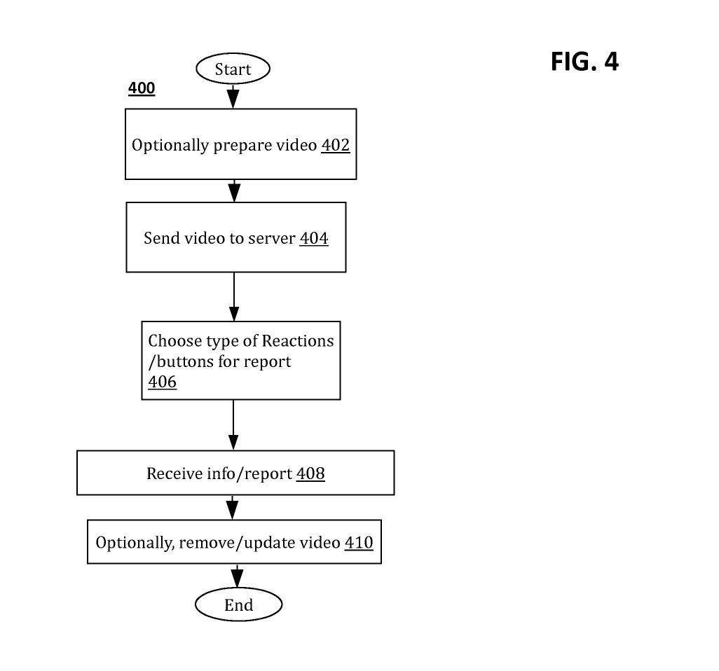

FIG. 4 shows a flowchart of an embodiment of an uploader-side method 400 for measuring and analyzing audience reactions to video in which the producer of a video is able to upload one or a few different versions of a video and gather audience reactions for video. The uploader can be a producer, videographer, owner, or interested party. The uploader may upload videos onto the server, which prepares them for serving over the internet. The videos may be given their own unique webpages, where the videos can be viewed and interacted with.

In step 402, the uploader or others optionally prepares the video. Alternatively, the video may be chosen from a public site and may be of interest to the uploader, making the uploader an interested party. In at least one embodiment, an uploader may want to compare the audience reaction to a competitor's video/advertisement. The uploader is not the owner, but is an interested party.

In step 404, the uploader sends or uploads the video to the server and/or website 404. In at least one embodiment, the uploader must register themself with the system/website/server in order to have the video analyzed. In at least one embodiment, the uploader provides the system with a live video stream. In an embodiment, audience reactions to this live video stream are recorded, analyzed and reported in real-time to the uploader, thus allowing the server to direct the content of the live video stream based on real-time feedback.

In step 406, the uploader chooses the type of reactions/buttons for the report 406. The uploader may choose to include audio, video and/or manual reactions. In at least one embodiment, the uploader is given a set of manual (buttons) reactions that are not changeable. The uploader may also choose whether to include an option for the viewer to comment on the video and/or to provide information about the viewer. In at least one embodiment, reactions captured can be content-specific, i.e. different reaction types can be chosen for videos about sports, education, news, entertainment, etc. For example, the reactions monitored for a sports game may be cheers and boos, while reactions monitored during an entertainment segment may be laughs, moans, and cries. Some other examples, a comedy may be monitored only for laughs and a drama may be monitored for crying, moaning, and/or other emotional outbursts.

In step 408, information or a report is received by the uploader. The report may be generated whenever the uploader decides to request the report. Alternatively, the report may be generated at specified times. The report may give details about the types of reactions of the viewers. After a given time or after a certain number of views, the uploader is sent a report and/or the uploader can access the report via the back end of the system site. For example, after a few hundred views of each uploaded video, the uploader may access the back end of the system and access the reports. In at least one embodiment, the uploader can choose the type of report (histogram, list, etc.) and the information that is contained in the report. For example, the uploader may want to have the reactions separated by the age, sex, education level, household income, area, type of home, and/or other demographics. Alternatively, the uploader may want to know how many viewings and how many of the viewers like the video and if there were multiple viewings by a single viewer.

The uploader may be given any type of report. However, in at least one embodiment, the uploader sees a timeline of each video with still images taken at regular intervals throughout the video. On this timeline, the uploader sees a histogram of reactions that have occurred throughout the video. On one video, for example, the uploader sees that an event where expensive cars are driven down a boulevard has prompted some negative reactions from viewers. Upon closer inspection of this cluster of reactions, the uploader sees that the reaction have been from 15-21 year old females. Since 15-21 year old females are the target audience of this particular music video, the uploader has received a valuable piece of information. The car scene should be edited out of the video before a wider release. In another video, a scene with a dog has prompted a positive reaction out of the same target audience, which again is a valuable signal to the uploader. The method allows for real-time recording of reactions to video content, instead of or in addition to rating the video after the fact. The method allows for the uploader of the video to get a much more detailed report of audience interaction.

In step 410, the uploader optionally chooses to remove the video from the website. The removing of the video may occur after a certain period of time has elapsed and/or after the uploader has received the information the uploader needs. In at least one embodiment, if the uploader does not expressly remove the video, the video is removed automatically after a certain amount of time has elapsed (e.g., 1 month, 1 year, etc.). In at least one embodiment, an email is sent to the uploader to warn the uploader of the impending removal of the video.

In an embodiment, each of the steps of method 400 is a distinct step. In at least one embodiment, although depicted as distinct steps in FIG. 4, step 402-410 may not be distinct steps. In other embodiments, method 400 may not have all of the above steps and/or may have other steps in addition to or instead of those listed above. The steps of method 400 may be performed in another order. Subsets of the steps listed above as part of method 400 may be used to form their own method.

FIG. 5 is a screenshot of a portion of webpage 500 in a graphical user interfaces for viewing content. Webpage 500 may include title 502, duration 504, display area 506, slider 508, volume control 510, and volume 520. In other embodiments, portion of webpage 500 may include additional components in addition to or instead of the elements listed above and/or may not include all of the components listed above. Webpage 500 presents an example of a portion of a graphical user interface according to at least one embodiment. While watching the video, the viewer has the option to react to events in the video by clicking on any of the reaction buttons provided in addition to the traditional video control buttons. In an embodiment, the viewer (or uploader) can also view reaction timelines specific to a demographic, or specific to their social profile. For example, a viewer can opt to see only the reactions of American females, or only of their friends, instead of all past audiences.

Title 502 is the title of the content being presented. Duration 504 is an indication of the duration of time that is required for presenting the content. Display area 506 is a region where video content appears if the content is a video. When only audio content is being presented, display area may be blank or may display an arrow indicating that the content is being played. Slider 508 indicates the timing of the content current being presented. The location of the nob in the slider indicates how much of the content has already been presented. In an embodiment a user may move the nob within slider 508 to a portion of the content desired, and that portion is presented. Volume control 510 may be selected to select the volume of any audio portion (if any) of the content being presented. Rating 512 is a rating assigned to the content based on input from individual user indicating what that user rates the content.

FIG. 5B shows a screenshot of an example of a portion 550 of a graphical user interface. Portion 550 may include vertical axis 552, horizontal axis 554, bars 556, rating input 558, 560 reaction graph, microphone input, 562, comment 564, upload 566, download 568, and sharing options 570 and 572. In other embodiments, portion 550 may include additional components in addition to or instead of the elements listed above and/or may not include all of the components listed above.

Portion 550 (of the graphical user interface) may be for the back end according to at least one embodiment. Using portion 550, the uploader of the video can see a chronological histogram or a chart of the various reactions to the video content, which can be selected for viewing separately or together. The chronological histogram may be overlaid on top of video thumbnail images taken of the video at even intervals or at points when audience interaction has been statistically significant to display the event that prompted the reaction. After the statistical analysis conducted on the reporting server, the reports show the combined audience reactions that are the most significant in terms of direction (for example, positive or negative), in terms of category (for example, humorous or serious) and in terms of strength (for example, combining all types of reactions to show the events that are most engaging to the audience). The clusters of reactions can be analyzed further in this view to reveal what audience demographics reacted in which way. This information is stored on the server databases, which are queried by the reporting backend constantly.

Vertical axis 552 is one of the axes of a graph indicating audience reaction. Different positions along vertical axis 552 represents different amounts of audience reaction. Locations along vertical axis 552 that are further from the horizontal axis may represents greater numbers of audience feedback, and locations along vertical axis 552 that are closer to the horizontal axis may lower numbers of audio feedback. Locations along vertical axis 552 above the horizontal axis may represent positive reactions, and locations along vertical axis 552 below the horizontal axis may represent negative audience reaction. Horizontal axis 554 may represent time. Locations along horizontal axis 554 further to the left may represent earlier times in the content being presented, and locations along horizontal axis 554 further to the left may represent earlier times in the content being presented. Bars 556 may represent the audience reaction. Bars above the horizontal axis 554 may represent a net positive reaction of the audience. Bars below the horizontal axis 554 may represent a net negative reaction of the audience. Taller bars may represent more viewers reacted or more viewers reacting in one particular way (e.g., positively) than another (e.g. negatively), and shorter bars may represent fewer viewers reacted and/or the fewer number of one particular reaction (e.g., positive) that was not cancelled by the other type of reaction (e.g., negative). Rating input 558 may allow the user to give an overall rating to the content. For example, rating input may allow a user to list the number stars that that user would assign to the content. Reaction graph 560 toggles the visibility of the reaction timeline between being visible and being hidden from view. Microphone 562 may allow the user to enter, comment 564 may cause a prompt to be displayed that asks the user to enter a comment. Upload 566 initiates uploading of content. Download 568 may allow the uploader to download the content with a report of the audience reaction. Sharing options 570 and 572 may include links to one or more social networks and/or other sites, where the user may want to post the content and/or audience reaction to the content.

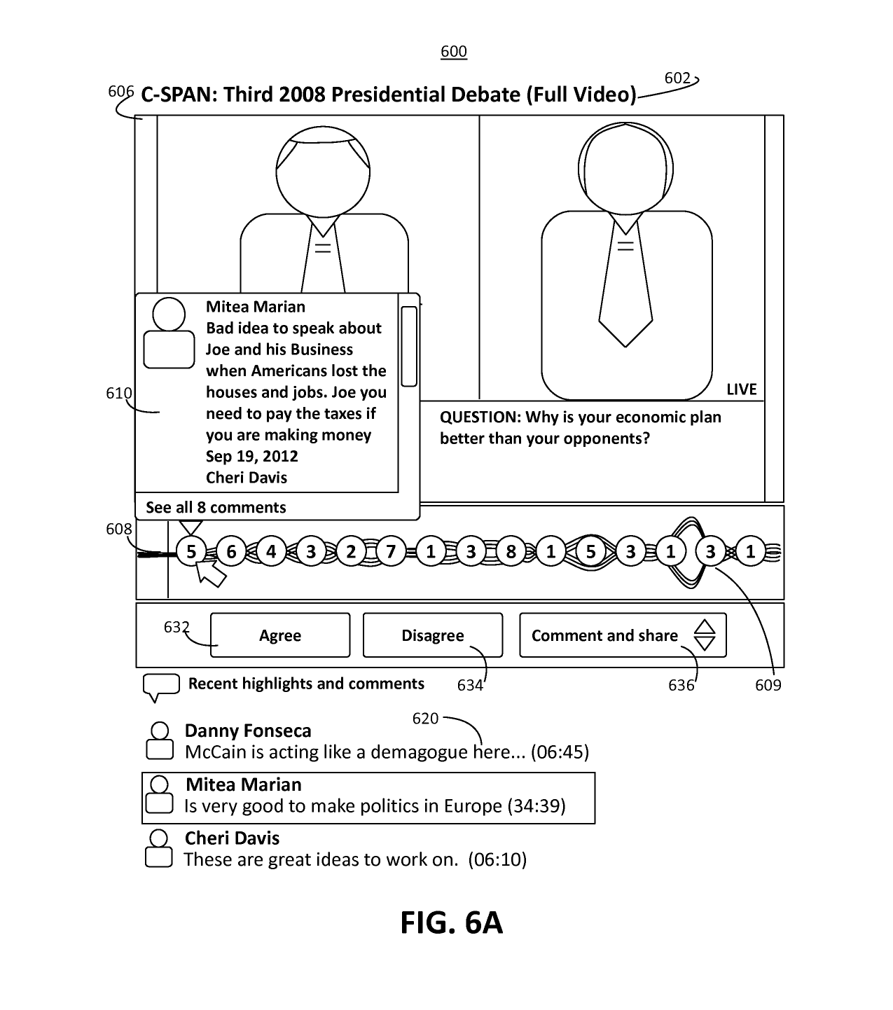

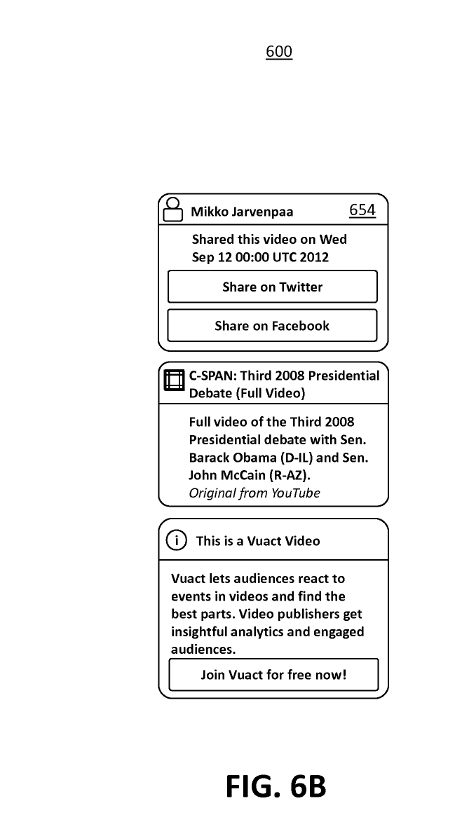

FIG. 6A is depiction of a portion of webpage 600 in a graphical user interface for viewing content. Webpage 600 may include title 602, display area 606, histogram timeline 608, histogram numbers 609, comment box 610, list of comments 620, agree button 632, disagree button 634, and comment button 636. In other embodiments, portion of webpage 600 may include additional components in addition to or instead of the elements listed above and/or may not include all of the components listed above. Webpage 600 presents an example of a portion of a graphical user interface according to at least one embodiment. While watching the video, the viewer has the option to react to events in the video by clicking on any of the reaction buttons provided in addition to the traditional video control buttons and/or to view other audience member's reactions and comments.

Title 602 is the title of the content being presented: C-SPAN: Third 2008 Presidential Debate (Full Video). Other information 604 provides an area to allow other websites that are related to include information, advertisements, and/or options to include comments (e.g., on Twitter, Facebook, etc.). Display area 606 is a region where video content appears if the content is a video—in this case, the 2008 presidential debate. When only audio content is being presented, display area 606 may be blank or may display an arrow indicating that the content is being played. Histogram timeline 608 indicates the summation of all other audience member's reactions. For example, in the case of this video, the number of audience members that “agreed” and “disagreed” is shown as a histogram with the number of audience members that agreed may be in blue and the number of audience members that disagreed may be in red, for example. The histogram numbers 609 are numbers in the histogram that represent the height of the histogram. In the embodiment of the FIG. 6, the lower numbers represent more reactions. Comment box 610 allows a user to click on an area in the histogram during the video to see other viewer's comments. The comment box 610 opens when a viewer clicks on a location on the timeline during which the comment was made. The list of comments 620 provides a list of the comments that were made about the video. Each comment includes an indication of the time/point in the video at which the comment was made. The comments in the list of comments 620 and in that appear in comment box 610 when the user clicks o the histogram timeline 604 may be the same comments. The agree button 632 allows a viewer to include his or her opinion by clicking on the agree button or the disagree button 634. The comment button 636 allows a viewer to include his or her comments about the video by clicking on the “comment and share” button. In an embodiment, the comment will be associated with the video at the time the “comment and share” button was clicked. In this way, other viewers can see the comment by choosing the histogram during that time and/or by viewing the list of comments 620.

FIG. 6B is a depiction of a portion 650 of webpage 600 in a graphical user interface for viewing content. Portion 650 may include other information 652. In other embodiments, portion 650 of webpage 600 may include additional components in addition to or instead of the elements listed above and/or may not include all of the components listed above.

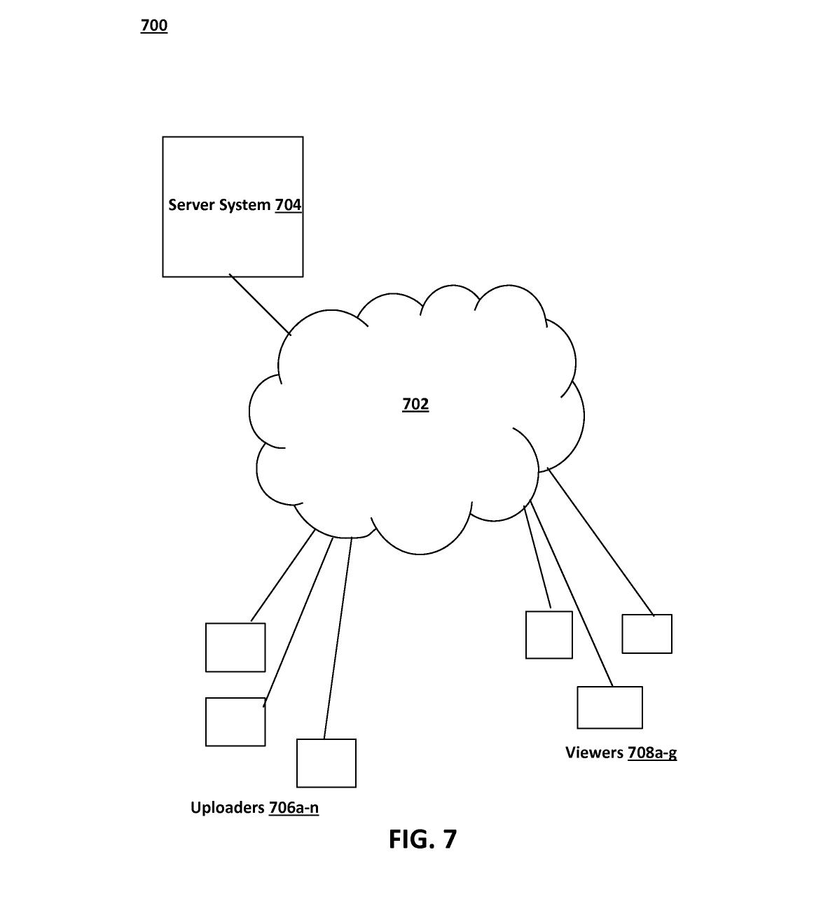

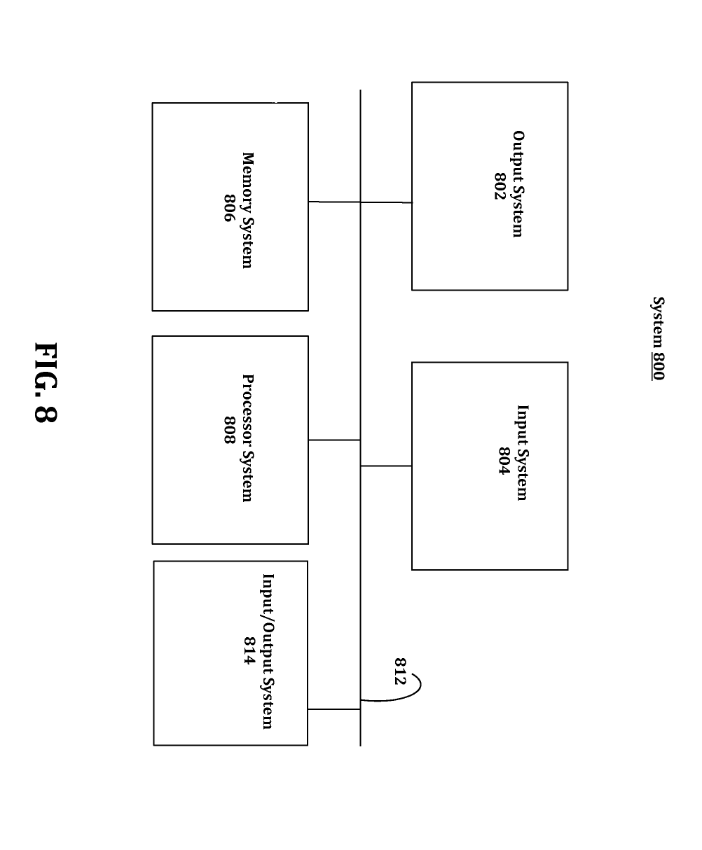

FIG. 7 shows a block diagram of a system 700 in which the system and method for measuring and analyzing audience reactions to video might be used. The system may include Internet 702, System 704, uploader 706a-g, and user(s) 708a-g. In other embodiments, computer 700 may include additional components in addition to or instead of the elements listed above and/or may not include all of the components listed above.

Network 702 is any network or combination of networks of devices that communicate with one another. For example, network 702 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” the Internet will be used in many of the examples herein. However, it should be understood that the networks that the one or more implementations might use are not so limited, although TCP/IP is a frequently implemented protocol.

System 704 may be any system that can be used to measure and analyze audience reactions to video. The system 704 allows for playing a video and receiving reactions from a viewer. The system 704 receives the reactions based on their content and timecode, analyzes the reactions by their category based on the preferences of the uploader, and by their statistical significance and strength. The system 704 also associates with the reaction the viewer information such as demographics or recent activity, if applicable. The system 704 stores the reactions and the associated information in a rapidly accessible standard database. The system 704 may include a front end by which the user/viewer can view the video and react and a back end by which the uploader can access the analysis and/or report. The system 704 and can take the viewer reactions and present them in a visual report to the uploader (e.g., in the reporting back end) based on time, audience demographics, etc. System 704 may include a front end for use by a viewer/use and a back end for use by an uploader (video producer, owner, etc.).

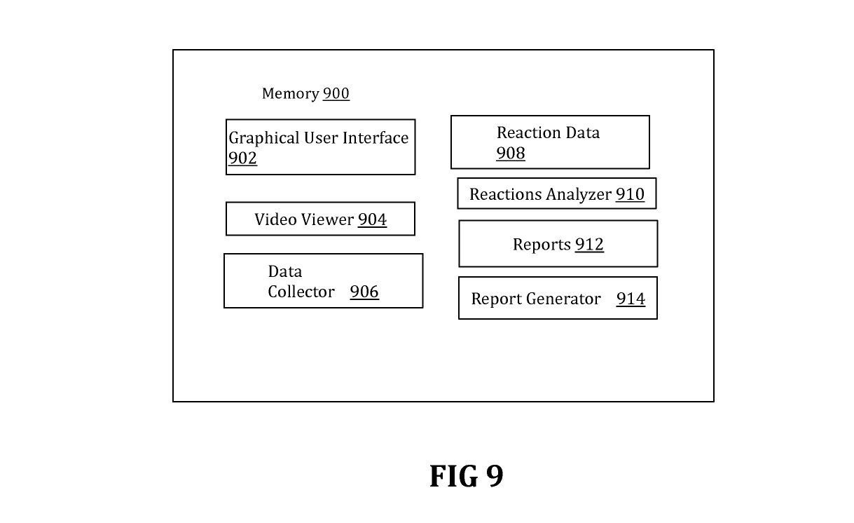

System 704 will be discussed further in conjunction with FIG. 8 and FIG. 9.

Uploader system(s) 706a-g may be any machine or system that is used by an uploader to upload and view video information. For example, uploader system 706 can be a handheld computing device, a mobile phone, a laptop computer, a work station, and/or a network of computing devices. As illustrated in FIG. 7 uploader system 706 might interact via a network 702.

Viewer system 708a-g may be any network appliance, which is any system capable of accessing a network that is used by a user to access a video and/or website related to measuring and analyzing reactions to video. For example, any of viewer systems 708a-g can be a computer, handheld computing device, a mobile phone, a laptop computer, a work station, and/or a network of computing devices. As illustrated in FIG. 7 viewer systems 708a-g might interact via a network 702.

FIG. 8 shows a block diagram of a computer 800 used in a system and method for measuring and analyzing audience reactions to video. The computer 800 may include output system 802, input system 804, memory system 806, processor system 808, communications system 812, and input/output device 814. In other embodiments, computer 800 may include additional components and/or may not include all of the components listed above.

The computer 800 may be an embodiment of the viewer the systems 708a-g, uploader systems 706a-g, and/or server system 704 (FIG. 7). Output system 802 may include any one of, some of, any combination of, or all of a monitor system, a handheld display system, a printer system, a speaker system, a connection or interface system to a sound system, an interface system to peripheral devices and/or a connection and/or interface system to a computer system, intranet, and/or internet, for example.

Input system 804 may include any one of, some of, any combination of, or all of a keyboard system, a mouse system, a track ball system, a track pad system, buttons on a handheld system, a scanner system, a microphone system, a connection to a sound system, and/or a connection and/or interface system to a computer system, intranet, and/or internet (e.g., IrDA, USB), for example.

Memory system 806 may include, for example, any one of, some of, any combination of, or all of a long term storage system, such as a hard drive; a short term storage system, such as random access memory; a removable storage system, such as a floppy drive or a removable drive; and/or flash memory. Memory system 806 may include one or more non-transitory machine-readable mediums that may store a variety of different types of information. The term machine-readable medium is used to refer to any medium capable carrying information that is readable by a machine. One example of a machine-readable medium is a computer-readable medium. If computer 800 is a viewer system or uploader system memory 806 may include an HTTP client, such as a browser. If computer system 800 is server system 704, memory system 806 may store a webserver and one or more machine instruction for implementing the methods of FIGS. 1-4 and graphical user interface.

Processor system 808 may include one or more processors, which may include any one of, some of, any combination of, or all of multiple parallel processors, a single processor, a system of processors having one or more central processors and/or one or more specialized processors dedicated to specific tasks. Processor system 808 may implement the machine instructions stored in memory system 806

Communications system 812 communicatively links output system 802, input system 804, memory system 806, processor system 808, and/or input/output system 814 to each other. Communications system 812 may include any one of, some of, any combination of, or all of electrical cables, fiber optic cables, and/or means of sending signals through air or water (e.g. wireless communications), or the like. Some examples of means of sending signals through air and/or water include systems for transmitting electromagnetic waves such as infrared and/or radio waves and/or systems for sending sound waves.

Input/output system 814 may include devices that have the dual function as input and output devices. For example, input/output system 814 may include one or more touch sensitive screens, which display an image and therefore are an output device and accept input when the screens are pressed by a finger or stylus, for example. The touch sensitive screens may be sensitive to heat and/or pressure. One or more of the input/output devices may be sensitive to a voltage or current produced by a stylus, for example. Input/output system 814 is optional, and may be used in addition to or in place of output system 802 and/or input device 804.

FIG. 9 shows a block diagram of a memory system 900 that can be used with the computer of FIG. 8 in a system and method for measuring and analyzing audience reactions to video. The memory system 900 may include graphical user interface 902, video viewer 904, data collector 906, reaction data 908, reaction analyzer 910, reports 912, and software for preparing reports 914. In other embodiments, memory system 900 may include other components in addition to or instead of the components listed above and/or may not include all of the components listed above.

Memory system 900 may be an embodiment of memory system 806. Graphical user interface 902 may include webpages that the viewer and uploader of the video interact with. For example, graphical user interface 902 may include one or more pages listing videos that were uploading having links and/or instructions for downloading the videos. Graphical user interface 902 may include one or more pages for uploading videos, which may provide options to the uploader to specify details about how the video is listed and/or the types of reactions to capture. Graphical user interface 902 may also include login pages (having fields for entering a password and/or user name) and/or registrations pages having fields for collecting information about a user, such as login information, payment information, and/or demographic information. Graphical user interface 902 may include webpages that generate the screenshots of FIGS. 5 and 6.

Video viewer 904 allows the user to view the video via network 702. Video viewer 904 may be part of a webpage and/or may be downloaded with the video for viewing the video on the viewer's machine.

Data collector 906 may be software that collects the data received via a recorder (video or audio) and/or the manual responses (pushing buttons) in an organized way that correlates the reactions with timepoints of the video. Data collector 906 may also be linked to keyboard input, input from a tracking device, an audio recorder and/or a video recorder for detecting and/or recording viewer's reactions. As the viewer watches the video, data collector 906 associates the reactions with timepoints and/or to associate the reactions with the personal information of the user. Data collector 906 may perform a certain amount of analysis of the reaction information collected, so that less information needs to be uploaded to server system Software may also be included for analysis of reactions, such as audio and video reactions at various points throughout the duration of the video. The software can be used to analyze the voice recording of the viewer and the analysis of the audible reactions to the video while watching it. In at least one embodiment, the voice recordings are automatically categorized into standardized categories, for example laughter, applause or booing. In at least one embodiment, the reactions are recorded by simultaneous video recording of the viewer and the analysis of their gestures.

Reaction data 908 can include any type of storage that is included in the memory (see also memory system 806 in FIG. 8).

Reaction analyzer 910 may perform statistical analysis of the reaction data 908. for example, reaction analyzer may compute a bargraph of the number of a particular type of reaction at a given point in the video. Reaction analyzer 910 may remove outliers so that the majority, median, or mode of the reactions are only included and/or so that the mean value is not skewed in a particular direction by what may be inaccurate data. In at least one embodiment, the statistics of reactions of certain groups of viewers can also be assessed based on information the viewers provide (or that can be ascertained in other ways). For example, reaction analyzer 910 may compute the percentage of viewers within the ages of 18-25 that found the video funny. In at least one embodiment, the reactions are constructed into a histogram that displays how the audience reacted to the video at various points throughout the duration of the video. In this embodiment the histogram can be, for example, displayed over a chronological thumbnail view of the video and/or along a timeline representing the length of the video, thereby indicating to the uploader of the video which portions of the video received a particular type of reaction. Reaction analyzer 910 may be used to analyze the voice recording of the viewer and the analysis of the audible reactions to the video while the viewer is watching the video. In at least one embodiment, the voice recordings are automatically categorized into standardized categories, for example laughter, applause or booing. In at least one embodiment, the reactions are recorded by simultaneous video recording of the viewer and the analysis of the user's gestures.

Reports 912 may include any type of reports about reactions of users to videos. Reports 912 is an area in memory 900 that stores prior generated reports.

The report generator 914 may include any software that generates reports, such as histograms, graphs, lists, etc. and presents the reports in an understandable manner. In at least one embodiments, algorithms are included that cause the reports to include information selected by the uploader, such as reactions correlated with personal information (e.g., age, sex, political party, etc.).

Example Use Case

A music video producer uploads multiple music videos every week. While the producers have a long experience in the field, the producer still knows that a good video is difficult to produce, because audience opinion about a new style of a video is impossible to forecast. At the same time, any new and groundbreaking music video styles would be very valuable to a video producer. The problem is that the producers do not have the tools to adequately test the videos. Thus far, the producers have been able to release different versions of the same song as different music videos and see which version gets rated the highest by the audience, but even when releasing different versions of the same song, the producers will not learn what content in the video exactly triggered a positive or negative audience reactions. The producer uploads different version of the song, waits for audience reaction and then downloads the song to see which parts of each version of the song were liked and not liked.

### Alternatives and Extensions

Regarding method 300 (FIG. 3), in at least one embodiment, the analysis is done using software that is downloaded to the viewer's computer instead of being performed on the server. In at least one embodiment, not everything the viewer does is recorded, but only the reactions, data representing the reactions, and/or the analysis of the reaction. In at least one embodiment, the reactions are videotaped and then recorded. In at least one embodiment, the reactions can be recorded by superimposing the analysis of the reactions in the margins of the video, such as at the bottom of the video. Software can be downloaded to the viewer's computer allowing the users computer to perform the analysis and then to upload the analysis and reactions to the server.

Each embodiment disclosed herein may be used or otherwise combined with any of the other embodiments disclosed. Any element of any embodiment may be used in any embodiment.

Although the invention has been described with reference to specific embodiments, it will be understood by those skilled in the art that various changes may be made and equivalents may be substituted for elements thereof without departing from the true spirit and scope of the invention. In addition, modifications may be made without departing from the essential teachings of the invention.

1. A method for reporting on reactions to video content, the method comprising:
receiving, at a server system, a request for content listed on a website of the server system, the server system including a processor system having one or more processors and a memory system, the content including different portions that are played in a sequence;
retrieving the content from the memory system;
sending, by the server system, the content;
receiving, at the server system, data about different viewer reactions to the different portions of the content played during the sequence, the viewer reactions including sensory human actions and expressions of opinion,
analyzing the data,
generating by the server system a report of the different viewer reactions, the report including a graphical timeline where viewer reactions correspond to particular segments of the video content.

2. The method of claim 1, the receiving, at the server system, of the data about the viewer reactions includes receiving manual input from the viewer and determining information about when the manual input was entered and a portion of the content being viewed when the manual input was entered.

3. The method of claim 1, the receiving, at the server system, of the data about the viewer reactions includes at least receiving information about audio reactions of the viewer.

4. The method of claim 1, the receiving, at the server system, of the data about the viewer reactions includes at least receiving information about visual reactions of the viewer.

5. The method of claim 1, further comprising combining reactions of a viewer into an analysis of the audience reactions and generating a graphical report of the analysis of audience reactions.

6. (canceled)

7. The method of claim 5, the analysis of audience reactions is correlated with the sequence in which the portions of the content were played.

8. The method of claim 1, further comprising receiving the content at the server; and posting the content at the server with a link for downloading the content.

9. The method of claim 1, the content including a video.

10. The method of claim 1, the content including an audio recording.

11. The method of claim 1, the content including a sequence of slides.

12. A system comprising:
a processor system including at least one processor; and
a memory system storing in one or more nontransitory machine readable media one or more machine instruction, which when implemented, cause the processor to implement the method of claim 1.

13. A method for reporting on reactions to video content, the method comprising:
sending, from a user system, a request for content listed on a website of a server system, the user system including a processor system having one or more processors and a memory system, the content including different portions that are played in a sequence;
receiving at the user system, from the server system, the content;
receiving, at the user system, machine instructions, which when implemented by the user system, cause the user system to collect data about different viewer reactions to the different portions of the content played during the sequence;
sending the data collected about different viewer reactions to the server system.

14. A method for reporting on reactions to video content, the method comprising:
sending, from a user system, a request to upload content to a website of a server system, the user system including a processor system having one or more processors and a memory system, the content including different portions that are played in a sequence;
after the content has been viewed by one or more viewers, receiving at the user system, from the server system, an analysis of viewer reactions to the content, the analysis including different viewer reactions to different parts of the content that were played in the sequence.

15. The method of claim 1, the content being a subset of an original set of content and the subset of the original set of content does not include all of the original set of content, the subset of the original set of content representing highlights of the original set of content.

16. The method of claim 15, further comprising selecting the subset of the original set of content based on a level of reaction to a part of the original set of content.

17. The method of claim 15, wherein the selecting is performed automatically based on the level of reaction.

18. The method of claim 15, the subset of the original content being arranged in a different sequence and order than content of the original content that is the same as the subset.

19. The method of claim 1, wherein the graphical timeline is a chronological histogram of viewer reactions on the same page as an image of the video content.

20. The method of claim 1, wherein
the graphical timeline displays different colors associated with different types of viewer reactions, and
the viewer may insert textual comments corresponding to particular segments of the video content.

21. The method of claim 1,
wherein the graphical timeline is a chronological histogram of viewer reactions displayed on the same page as an image of the video content,
the histogram having
different colors indicating different types of viewer reactions,
encircled numbers, the encircled numbers
being embedded into the histogram, and
indicating how many textual comments are associated with a particular time point of the timeline associated with the encircled numbers;
the method further comprising:
receiving from a viewer a selection of an encircled number,
sending to the viewer the textual comment(s) corresponding to the selected encircled number,
analyzing the reactions of particular viewer demographics, and
sending viewer demographics analysis to a video content provider.
